(19) United States
(12) Patent Application Publication
(10) Pub. No.: US 2025/0275555 A1
(43) Pub. Date: Sep. 4, 2025

(54) GEL STRUCTURE TO FACILITATE LIVE FEED SUBSTITUTON FOR EARLY LIFE STAGES OF AQUATIC ORGANISMS

(71) Applicant: Nutreco IP Assets B.V., Boxmeer (NL)

(72) Inventors: Seong-Chea CHUA, RANDABERG (NO); Philippe DHERT, Steenhuize-Winjhuize (BE)

(73) Assignee: Nutreco IP Assets B.V., Boxmeer (NL)

(21) Appl. No.: 18/857,719

(22) PCT Filed: Apr. 19, 2023
(86) PCT No.: PCT/NO2023/050088

§ 371 Date: Oct. 17, 2024

(30) Foreign Application Priority Data
Apr. 19, 2022 (NO) 20220448

(51) Int. Cl. A23K 10/30; A23K 20/158; A23K 20/179; A23K 40/10; A23K 50/80

(52) U.S. Cl. CPC A23K 10/30; A23K 20/158; A23K 20/179; A23K 40/10; A23K 50/80

(57) ABSTRACT

A nutrimental complement suitable for ingestion by larvae of shrimp or fish. The nutrimental complement has a particulate gel structure including agar, an attractant and water; and an aqueous medium having at least one salt. The particulate gel structure may be formed into gelled particles, e.g., granules, and the gelled particles may be added to the aqueous medium. A method is for preparing the nutrimental complement and a method is for co-feeding the nutrimental complement to shrimp larvae or fish larvae with at least one wet or dry feed, e.g., a complete wet or dry feed.

### CROSS-REFERENCE TO RELATED APPLICATIONS

This application is the U.S. national stage application of International Application No. PCT/NO2023/050088, filed Apr. 19, 2023, which international application was published on Oct. 26, 2023, as WO 2023/204719 in the English language. The International Application claims priority to Norwegian patent application Ser. No. 20/220,448, filed Apr. 19, 2022. The international application and Norwegian application are both incorporated herein by reference, in their entirety.

### FIELD

The present invention relates to a nutrimental complement suitable for ingestion by larvae of shrimp or fish. The nutrimental complement comprises a particulate gel structure that may be in the form of gelled particles such as granules. The gel structure is dispersed in an aqueous medium comprising at least one salt, e.g., sodium chloride. The invention also relates to a method of preparing the nutrimental complement. The invention relates further to a method of co-feeding the larvae of shrimp or fish with the nutrimental complement and with at least one wet or dry feed, e.g., a complete wet or dry feed.

### Abbreviations

ALF artificial life feed
ALF (P), ALFP pasteurized artificial life feed fed
ALFF artificial life feed fed at fixed feeding regime
ALFV artificial life feed fed at variable feeding regime
ART Artemia
DD dry diet
M1, M2, M3 mysis stage 1, 2, 3
N5 nauplii stage 5
Z1, Z2, Z3 zoea stage 1, 2, 3
PLn post larvae stage n

### BACKGROUND

Despite a progressive improvement in the physical and nutritional performance of dry diets for the larval culture of marine finfish and shrimp species, it remains essential to provide them with live feeds at critical stages in their early development. Live feed consists primarily of rotifers and Artemia but sometimes also about wild zooplankton that is harvested from nature or produced at the hatchery site.

Because of the constant biohazard risk for vectoring diseases through the live feed production on one hand, and the insufficient and variable nutritional condition of these wet feeds on the other hand, numerous disinfection and enrichment procedures have been developed. All these handlings and treatments finally add several extra operational costs but are essential to upgrade live feed to the status of an acceptable wet diet.

Many attempts have been made to completely integrate the nutritional components of live feed in so called dry or wet replacement diets but without complete satisfaction. Sophisticated dry diets, often produced on pharmaceutical equipment, such as micro bound particles, micro coated particles, protein walled microcapsules, etc. have been developed to contain all possible nutrients and chemical features to fulfill the needs of small aquatic animals, but very often fail to match the correct balance between water stability, particle digestibility and buoyancy.

Wet diets, due to their higher water content generally result in more buoyant formulations but encounter higher leaching and preservation challenges to retain peptides, amino acids, vitamins, and highly oxidative essential lipophilic and hydrophilic compounds in one matrix.

Probably the best compromise to solve the problem of live feed substitution consists in combining the best of the properties of wet and dry diets by co-feeding them. Co-feeding dry feeds with live feeds prior to weaning are well established procedures that could be further explored to dry and wet diets by mimicking the feeding strategies that are used today with live feed. For shrimp and fish that means that during the critical stages preceding the molts to early PL stages (post larval stages; for shrimp) and pre-metamorphosis (for fish), live feed could be reduced to its bare essential functions and elements that are lacking in dry diets. The invention has for its object to remedy or to reduce at least one of the drawbacks of the prior art, or at least provide a useful alternative to prior art.

Live feed having been analyzed for many decennia constitutes hardly any secrets on the nutritional components constituting its body composition. The functional nutrients are very well known and can be incorporated in the dry diet without need for replication in the wet diet formulation. In this respect the wet diet can better be used as a complement for chemically incompatible nutrients in the dry diet, but it could as well be used to compensate temporary specific boosts during critical stages. High organoleptic attractable molecules and excellent physical buoyancy characteristics should further trigger the interest of the larvae to ingest these new generation wet diets on demand.

The life cycle of penaeid shrimp involves egg, nauplius stages (1-6), zoea stages (1-3), mysis stages (1-3), post larvae stages (PLn), juvenile stage, subadult stage and adult stage. The life cycle of fish depends on the fish species, but typically involves eggs, larva, juvenile fish, and adult fish, although for some fish species this may be different.

Artemia is used in most shrimp hatcheries, but its use is very restricted to the larval rearing period where it forms a small part in the total volume of formulated (dry) diets that are being offered. The average Artemia cyst consumption is generally restricted to 1-5 kg cysts per million of shrimp produced.

Reasons for the restricted use of Artemia are multiple, but the most important ones are cost, biohazard issues, sustainability, chemical contamination, variable hatching and quality issues. Despite all these issues, Artemia is still used as it plays a unique role to overcome the critical stages in the early shrimp development from mysis to early postlarva (PL).

The Artemia factor giving the extra benefit to shrimp larvae has been investigated for many years but never completely unravelled. Hypotheses are numerous: buoyancy and movement, digestibility of an easy autolysing organism, accompanying bacterial communities, micronutrients, enzymes, hormones, etc.

Most likely, the Artemia factor is the result of a complex multifactorial combination of physical, microbial and nutritional combinations that are difficult to copy because highly variable but still working complementary as for instance, but not restricted to:
digestive enhancing properties due to simple hydration of dry feed by life food containing approximately 90% water;
a re-colonization of the gut of the larvae by different microbial communities released from the rapidly autolyzing body and release of the bacterial gut flora of the live feed after ingestion by fish or shrimp;
the protection of the gut by a soft matrix formed by life feed and the harder dry diet;
the consistency and movement of life prey facilitating the peristaltic movement of the gut.

### Dry and Wet Feeds

Dry feed particles ranging in size from, for example, 50 μm to 100 μm, 100 μm to 200 μm, 200 μm to 300 μm, 300 μm to 400 μm and 400 μm to 500 μm are offered in accordance with the size and developmental stage of the shrimp and fish.

Wet feeds are generally following similar size classes as they tempt to replace completely the dry feeds and/or Artemia. These feeds consist of a mixture of a gelling substance/binder, water and a complete list of nutritional ingredients i.e., fat sources, protein sources, minerals, vitamins etc. Other wet feeds have been designed for on-growing fish or shrimp in aquaculture, long after they have been weaned off life food. Some wet feeds are only used by hobbyists in aquaria where the animals are not used in the food chain.

WO02/078463 discloses a formulated micro bound diet product for the culture of larval fish and crustaceans either in a dry or moist form which contains proteins such as fish protein hydrolysate, casein, and egg yolk, and binding agents such as soy lecithin, wheat gluten, and alginate.

WO02/071867 discloses a solid, non-liquid particulate foodstuff composition which is effective for meeting the nutritional needs of aquatic life. The foodstuff of the invention includes oil-coated nutrient and moisturized nutrient feed particles which are embedded in a gel or an ingestible polymer blend. The gel which is gelled alginate and gelatine is crosslinked by a water soluble multivalent, antimicrobial salt such as calcium chloride.

EP 1006807 discloses a feed for aquatic animals for use as replacement for frozen feed in the form of viscous gel comprising 0.001 to 50% gelling agent, 0.1-90% of natural nutriment at a water content of 20-99% and a viscosity of 1 to 2·10⁶ mpa·s.

The invention has for its object to remedy or to reduce at least one of the drawbacks of the prior art, or at least provide a useful alternative to prior art. More specifically, it is an object of the present invention to improve feeding of fish and/or shrimp larvae, preferably without using live feeds, and/or to improve growth and/or survival of fish larvae and/or shrimp larvae.

The object is achieved through features, which are specified in the description below and in the claims that follow.

### SUMMARY

The gist of the present invention is to move away from a complete dry or wet diet (i.e., a nutritional complete diet) and to focus on the shortcomings of the dry diet or the wet diet, particularly for the period in which larval shrimp and larval fish are encountering difficulties in specific moulting stages, weaning or diet transition. In this period the animals are undergoing profound transformations with extra dietary and digestive requirements, but they still have poorly developed digestive systems that rely on the interactions of live feed and bacteria to partly digest the ingested feeds. Without wishing to be bound by theory, it is hypothesized that the gist of the invention is to replace the specific function of live feeds by forming a nutrimental complement, i.e., a physico-nutritional particulate gel structure dispersed in an aqueous medium comprising at least one salt, e.g., brine, to facilitate the ingestion and digestion of the co-fed dry diet. The particulate gel structure is buoyant, rich in moisture, but also available for bacterial adherence and electrolyte exchange.

The present disclosure concerns a nutrimental complement comprising a particulate gel structure preserved in an aqueous medium comprising at least one salt, which nutritional complement replaces the functions of live feed. The nutrimental complement is preferably co-fed with a conventional and/or commercial formulated dry feed during the critical transformation of larval shrimp and larval fish stages.

It has surprisingly been found that co-feeding this nutrimental complement, which is nutritionally incomplete, i.e., does not comprise all nutrients required for rearing of fish larvae and/or shrimp larvae, with the formulated dry feed which is nutritionally complete per se, improves the survival rate of shrimp larvae from Mysis to early PL stages to the same extent as co-fed live feed.

According to one aspect of the present disclosure, the particulate wet gel structure may be pre-formed by gel-congealing based on a mixture of a gelling agent, an attractant, and water, and optionally a colourant, an omega-3 fatty acid, and a phospholipid.

As used herein, the term “weight percentage” or “wt %” refers to a weight percentage on a wet-weight basis, also known as an “as-is basis”, i.e., water or moisture is part of the composition to which inclusion level of each specified component is calculated. This is different to dry basis which is expressed as the weight of the specified component as a percentage of a completely dry solid, i.e., excluding the water or moisture content.

After gel-congealing the nutrimental complement may be obtained by wet sieving of the particulate gel structure and dilution of the particulate gel structure in an aqueous medium comprising at least one salt. The aqueous medium comprising at least one salt may comprise approximately 100-200 ppt NaCl. The nutrimental complement may be stored in cans.

The invention is defined by the independent patent claims. The dependent claims define advantageous embodiments of the invention.

In a first aspect the present disclosure relates to a nutrimental complement suitable for ingestion by larvae of shrimp or fish, comprising:
I) a particulate gel structure comprising:
   a) agar;
   b) an attractant; and
   c) water;
and
II) an aqueous medium comprising at least one salt.

The nutrimental complement may further comprise an ingredient selected from a group consisting of a colourant, an omega-3 fatty acid, and a phospholipid, or any combination thereof. In an alernative embodiment the nutrimental complement further comprises a colourant, an omega-3 fatty acid, and a phospholipid.

The aqueous medium may comprise at least 80 ppt, such as at least 100 ppt, at least 125 ppt, at least 150 ppt, at least 175 ppt, or at least 200 ppt, salt. The aqueous medium may comprise at most 500 ppt, preferably at most 400 ppt, more preferably at most 300 ppt, even more preferably at most 250 ppt, salt. The salt may be any salt. The skilled person will be able to select a suitable salt. The salt may include, without limitation, sodium chloride, magnesium chloride, calcium chloride, potassium chloride, sodium carbonate, magnesium carbonate, calcium carbonate, potassium carbonate, sodium sulfate, magnesium sulfate, calcium sulfate, and potassium sulfate, or any combination thereof. In a preferred embodiment, the aqueous medium comprises sodium chloride, preferably at least 80 ppt, such as at least 100 ppt, at least 125 ppt, at least 150 ppt, at least 175 ppt, or at least 200 ppt sodium chloride, and at most 400 ppt, such as at most 350 ppt, at most 325 ppt, at most 300 ppt, or at most 250 ppt, sodium chloride. Sodium chloride has the advantage that it may act as a preservative to prevent spoilage of the nutrimental complement taught herein. However, also other salts may be used for this purpose. The aqueous medium may further comprise other salts as taught herein.

The particulate gel structure may be in the form of individual gelled particles such as granules, preferably granules having a particle size between 1 μm and 2 mm. The granules may be between 5 μm and 800 μm, such as between 20 μm and 600 μm, such as between 50 μm and 300 μm, such as between 50 μm and 200 μm. The particulate gel structure may be congealed into individual granules having such particle size. The particulate gel structure may also be reffered to as particulate wet congealed gel structure to emphasize that the gel structure may have been prepared by mean of congealing, and hence is in a solid (albeit gelled) state and that the particles have not been dried after congealing or gelling.

The particulate gel structure, e.g., in the form of gelled particles such as granules, may be floating, slow-sinking, or preferably neutrally buoyant, i.e., it remains in the water column without sinking or rising. It may, for example, have a density of between 0.995 and 1.200 g/ml. Such density allows for a suitable buoyancy, e.g., neutral buoyancy, in water tanks typically used for rearing fish and/or shrimp larvae.

The gelled particles, e.g., granules, may be obtained by compressing, spraying, coagulation, flocculation or other techniques. The use of the agar keeps the various constituents together. The gelled particles, e.g., granules may themselves also comprise smaller particles. The gelled particles, e.g., granules may have any form, for example they may be round, oval, square or elongated like a grain.

The particulate gel structure or the nutrimental complement as taught herein may comprise between 0.01 and 10 wt %, such as between 0.05 and 7.5 wt %, between 0.1 and 6 wt %, between 0.5 and 5 wt %, between 1 and 4 wt %, between 1.5 and 3 wt %, or between 1.5 and 2.5 wt %, agar on wet-weight basis.

The attractant may be an amino acid, a mixture of amino acids, dipeptides, polypeptides, a mixture of dipeptides, a mixture of polypeptides, a mixture of dipeptides and polypeptides, a hydrolysed protein source, wherein the protein source may be of vegetal origin or of animal origin, wherein the protein source may be of aquatic or marine origin, such as zooplankton and fish, and a mixture of any of amino acid, dipeptide, polypeptide and hydrolysed protein source. The attractant may be provided as a dry powder, a wet paste or as a solution. The attractant may be present in the particulate gel structure or the nutrimental complement taught herein in an amount of between 0.0001 and 20 wt %, such as between 0.0005 and 18 wt %, between 0.001 and 16 wt %, between 0.005 and 14 wt %, between 0.01 and 12 wt %, between 0.05 and 10 wt %, between 0.1 and 8 wt %, or between 0.5 and 6 wt %.

The omega-3 fatty acid may preferably be selected from eicosapentaenoic acid (EPA) and docosahexaenoic acid (DHA), and is preferably DHA. Fish meal, fish oil, marine algae and phytoplankton are primary sources of EPA and DHA, and DHA and EPA accumulate in larval fish and/or shrimp that eat these algae and phytoplankton. However, presently also omega-3 fatty acids are available from (optionally genetically modified) plant sources, such as Brassica species. The omega-3 fatty acid may in one embodiment be from animal origin. The omega-3 fatty acid source may in an alternative embodiment be from a vegetal origin. The omega-3 fatty acid source may comprise DHA from an animal origin. Alternatively, or additionally, the omega-3 fatty acid source may comprise DHA from a vegetal origin. The omega-3 fatty acid, e.g., DHA, may be present in the particulate gel structure or the nutrimental complement taught herein in an amount of between 0.001-wt %, such as between 0.005 and 18 wt %, between 0.01 and 16 wt %, between 0.05 and 14 wt %, between 0.1 and 10 wt %, or between 0.5 and 6 wt %.

The phospholipid may comprise lecithin. Lecithins are mixtures of glycerophospholipids including phosphatidylcholine, phosphatidylethanolamine, phosphatidylinositol, phosphatidylserine, and phosphatidic acid. As such, they are a good source of various phospholipids. The lecithin may be from any source available, including, without limitation, egg yolk, marine sources, soybeans, milk, rapeseed, cottonseed, and sunflower oil. In one embodiment the lecithin may be soy lecithin. The phospholipid, e.g., lecithin, may be present in the particulate gel structure or the nutrimental complement taught herein in an amount of between 0.01-20 wt %, such as between 0.05 and 15 wt %, between 0.1 and 10 wt %, or between 0.5 and 6 wt %.

The colourant may be any colourant that serves to make the particulate gel structure visible in the water tanks typically used for rearing shrimp and/or fish larvae. The colourant may be a pigment, a dye, or an ionized solution. In an embodiment, the colourant may be selected from the group consisting of carotenoids, such as carotenes or xanthophylls, carbon, clay, minerals, anthocyanins, coloured algae, such as red or green algae, and the like. In an embodiment, the colourant may be a carotenoid, preferably a xanthophyll, even more preferably astaxanthin.

The colourant may be present in the particulate gel structure or the nutrimental complement taught herein in an amount of between 0.0001 and 20 wt %, such as between 0.0005 and 18 wt %, between 0.001 and 16 wt %, between 0.005 and 14 wt %, between 0.01 and 12 wt %, between 0.015 and 10 wt %, between 0.02 and 8 wt %, between 0.1 and 6 wt %, or between 0.5 and 5 wt %, depending on the type of colourant used. The skilled person is capable of selecting the correct amount of colourant needed to obtain the desired effect.

The particulate gel structure may, for example, comprise 0.01-10 wt % agar, 0.01-10 wt % of attractant, 0.1-3 wt % DHA, 0.01-10 wt % phospholipid, 0.01-20 wt % of colourant, and 40-95 wt % water on wet-weight basis.

The weight ratio between the particulate gel structure and the aqueous medium may be between 0.2:1 to 1:0.2, preferably 0.5:1 to 1:0.5, more preferably 0.75:1 to 1:0.75.

In a second aspect the present disclosure relates more particularly to a method of preparing a nutrimental complement suitable to be co-fed to shrimp larvae or fish larvae as taught herein, wherein the method comprises the steps of:
i) congealing a gelling mixture comprising agar, water and an attractant, and optionally an omega-3 fatty acid, a phospholipid and/or a colourant to form a particulate gel structure, such as granules;
ii) optionally, wet sieving the particulate gel structure, such as granules, to obtain appropriately sized particulate gel structure; and
iii) adding the particulate gel structure to an aqeuous medium comprising at least one salt to obtain a nutrimental complement suitable for ingestion by larvae of shrimp or fish.

The gelling mixture is preferably congealed by heating the gelling mixture to a temperature allowing the agar in the gelling mixture to melt, and subsequently allowing the gelling mixture to solidify, e.g., by forming appropriate particles and allowing them to solidify. The skilled person knows how to determine a suitable temperature to allow the agar in the gelling mixture to melt, and the skilled person also knows how to determine a suitable temperature to allow the gelling mixture to solidify.

In one embodiment the gelling mixture may be prepared by:
a) mixing water, an attractant, and optionally an omega-3 fatty acid, a phospholipid and/or a colourant;
b) heating the mixture of a); and
c) adding agar to the mixture during heating to form the gelling mixture.

In an alternative embodiment the gelling mixture may be prepared by:
a1) mixing water, agar, an attractant, and optionally an omega-3 fatty acid, a phospholipid and/or a colourant; and
b1) heating the mixture of a1) to form the gelling mixture.

In an alternative embodiment the gelling mixture may be prepared by:
a2) mixing water and agar
b2) adding an attractant, and optionally an omega-3 fatty acid, a phospholipid and/or a colourant to the mixture of a2); and
c2) heating the mixture of b2) to form the gelling mixture.

In an alternative embodiment the gelling mixture may be prepared by:
a3) mixing water and agar
b3) heating the mixture of a3)
c3) adding an attractant, and optionally an omega-3 fatty acid, a phospholipid and/or a colourant to the mixture of b3) to form the gelling mixture.

The present disclosure also provides a nutrimental complement obtainable by any preparation method taught herein.

In a third aspect the present disclosure relates more particularly to a method of feeding shrimp larvae or fish larvae comprising co-feeding the larvae of shrimp or fish with the nutrimental complement as taught herein and at least one wet or dry feed, e.g., a complete wet or dry feed. As used herein, a wet feed comprises more than 10 wt % of water on an wet-weight basis. A dry feed comprises 10 wt % of water or less on an wet-weight basis. A complete wet feed and a complete dry feed are diets that cover all nutrient requirements for healthy growth of a shrimp or a fish at a particular life stage. Suitable wet and dry feeds are commercially available. The skilled person knows how to select an appropriate wet or dry feed to be co-fed with the nutrimental supplement taught herein.

In a fourth aspect the present disclosure relates to a method of increasing survival of larvae of shrimp or fish, wherein the method comprising the step of co-feeding a nutrimental complement as taught herein and at least one wet or dry feed.

In a fifth aspect the present disclosure relates more particularly to a method of increasing total biomass of larvae of shrimp or fish, said method comprising the step of co-feeding a nutrimental complement as taught herein and at least one wet or dry feed. The nutrimental complement may be co-fed with the at least one wet or dry feed during the hatchery phase.

In a sixth aspect the present disclosure relates more particularly to a method of increasing growth of larvae of shrimp or fish, wherein the method comprising the step of co-feeding a nutrimental complement as taught herein and at least one wet or dry feed. The nutrimental complement may be co-fed with the at least one wet or dry feed during the hatchery phase. The increased growth may be observed during the nursery phase, whereas the nutrimental complement taught herein is being co-fed with the at least one wet or dry feed during the hatchery phase. Hence, the larvae may be in a better health status when fed the nutrimental complement taught herein and the at least one wet or dry feed when they come out of the hatchery phase, which carries through into the next development stages.

In a seventh aspect the present disclosure relates more particularly to a method of reducing germs, such as harmful microbes, fungi, and viruses, in the rearing of fish or shrimp larvae, said method comprising the step of co-feeding a nutrimental complement as taught herein and at least one wet or dry feed. The reduction of germs is compared to using live feed. Without wishing to be bound by theory, it is hypothesized that the reduced number of germs observed during rearing is due to the absence of live feed, which is known to carry germs, in the rearing process.

In an eight aspect the present disclosure relates more particularly to a method of reducing waste in the rearing of fish or shrimp larvae, said method comprising the step of co-feeding a nutrimental complement as taught herein and at least one wet or dry feed.

In a ninth aspect the present disclosure relates more particularly to a nutrimental complement as taught herein for use in increasing survival of larvae of shrimp or larvae of fish.

In a further aspect, the present disclosure provides the use of a nutrimental complement as taught herein for the manufacture of a composition for increasing survival of larvae of shrimp or larvae of fish.

The nutrimental complement and the at least one wet or dry feed may be fed to the larvae of shrimp or larvae of fish at the same frequency or at different frequencies, for example, such that the nutrimental complement is fed to the larvae of shrimp and larvae of fish at a lower frequency than the at least one wet or dry feed. The amount of the nutrimental complement that may be fed on a daily basis is dependent on the larval stage of the fish larvae or shrimp larvae. The same holds true for the amount of the at least one wet or dry feed. The nutrimental complement may be co-fed with the at least one wet or dry feed during the hatchery phase.

### BRIEF DESCRIPTION OF THE DRAWINGS

FIGS. 1A-B show survival (in %; FIG. 1A) and average weight (in mg; FIG. 1B) of shrimp larvae at the PL12 stage fed a dry diet (DD), alone or together with either Artemia (DD ART), pasteurized ALF (DD ALFP) or non-pasteurized ALF (DD ALF). The four bars per treatment depict the results for each replicate;

FIGS. 2A-C show survival (in %; FIG. 2A), and average weight (in mg; FIG. 2B) of shrimp larvae at the PL12 stage fed a dry diet alone (DD), together with Artemia (DD ART), or together with ALF (DD ALFF and DD ALFV, respectively; ALFF being fed in a fixed daily ration, whereas ALFV was fed in a variable daily ration in the Z3/M1 through PL4 stage). FIG. 2C depicts survival plotted as function of weight of the larvae;

FIGS. 3A-B show survival (in %; FIG. 3A), and average weight (in g; FIG. 3B) of shrimp in nurseries fed either DD ART or DD ALF during the hatchery phase. All shrimp received a commercial nursery diet during the nursery phase;

FIG. 4A-B show molting stage distribution (FIG. 4A) and corresponding survival (FIG. 4B) of shrimps two days after the mysis stage; and

FIGS. 5A-B show differences of developing Vibrio colonies in the treatments with ALF (FIG. 5A) and the difference on the waste obtained after siphoning (FIG. 5B).

### DETAILED DESCRIPTION OF THE DRAWINGS

### Examples

In the examples it was investigated if some of the physical characteristics of Artemia could be mimicked by a simplified artificial life feed (ALF) as taught herein as the nutrimental complement. Moreover, it was investigated if ALF could fully replace Artemia in larval diets. It was further investigated if the combined use of a commercially available dry diet (DD) and the nutrimental complement as taught herein (ALF) could be an alternative solution to the existing weaning strategy for shrimp and/or fish larvae, which is using Artemia as a co-feed with commercially available dry diets.

Important beneficial features can be added to overcome some of the bottlenecks in the use of live feed. These are for instance, but not restricted to:
the use of a bigger particle size range with ALF compared to live feed;
the use of a hygienic and controlled production process in a clinical environment reducing the biohazard of live feed;
the use of an off the shelf available product unlike live feed that needs to be upscaled, maintained disinfected and enriched;
a product with a natural buoyancy and equal presence in the water column making it easy to dose and control compared to live feed that is phototactic, concentrates, grows (Artemia) or even reproduces (rotifers) and multiplies in the larval shrimp or fish tanks.

Since the ALF is not a complete feed, but more a physical dummy for live feed, it is preferably used in a restricted time frame. Since it is co-fed with a dry diet that provides all nutrients required by the larvae, replacing Artemia with ALF will not cause feeding deficiencies. In the examples with P. vannamei ALF has been used during the critical molting stages M3-PL5 at a dosage of 0.5-3 kg per million shrimp produced. For fish and other shrimp species ALF may be used during the same or at different stages, and in similar or different amounts.

### Diets

The dry diet (DD) used in the examples 1-6 hereinbelow was a commercially available dry feed intended for feeding shrimp at the molting stages M3-PL5.

### ALF

To obtain the artificial life feed (ALF)/nutrimental complement as taught herein, a gelling mixture comprising agar, water, marine protein hydrolysate, astaxanthin, DHA, and lecithin was spray congealed into granules that were wet sieved to obtain a size fraction between 50-200 μm. The spray congealed granules comprised 2 wt % agar, 5 wt % of attractant (based on dry matter; in the form of marine protein hydrolysate), 0.2 wt % of DHA, 0.5 wt % lecithin, 0.2 wt % astaxanthin and 92.1 wt % water. The granules were kept in an aqueous salt solution comprising NaCl (at 150 ppt salinity) to form the nutrimental complement. The weight ratio of granules to aqueous salt solution was 1:1. The nutrimental complement was offered as such to the shrimp larvae. The nutrimental complement (comprising a weight ratio of granules to aqueous salt solution of 1:1) contained 78% water, 14% ash, 4% fat, 3% carbohydrates and about 1% protein. The granules were pasteurized at 60° C. for 60 minutes to obtain ALFP.

### Husbandry

The shrimp tests were performed in 60 l tanks in 4 replicates. For the hatchery phase, the shrimp were stocked at nauplius stage at a density of 130 nauplii per litre.

Artemia or ALF was fed 6 times a day from Z3/M1 till PL6.

Water temperature was maintained at 29° C.±1° C.; oxygen at 4.5 mg/l±0.5 mg/l and pH at 8.2±0.2. Water was full strength sea water (35 ppt).

### Example 1

The test consisted of 4 treatments:
DD ART: Dry diet and Artemia
DD: Dry diet
DD ALFP: Dry diet+pasteurized ALF
DD ALF: Dry diet+ALF

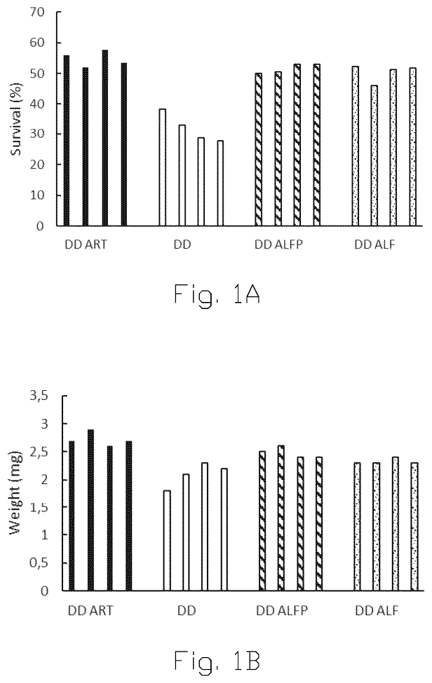

Co-feeding dry diet together with Artemia, pasteurized ALF, or ALF resulted in an increased survival (FIG. 1A) and average weight (FIG. 1B) compared to feeding dry diet alone. No statistically significant difference was found between the DD ART and the DD ALFP and DD ALF feeding methods. Thus, the ALFP and ALF are suitable ART replacers.

### Example 2

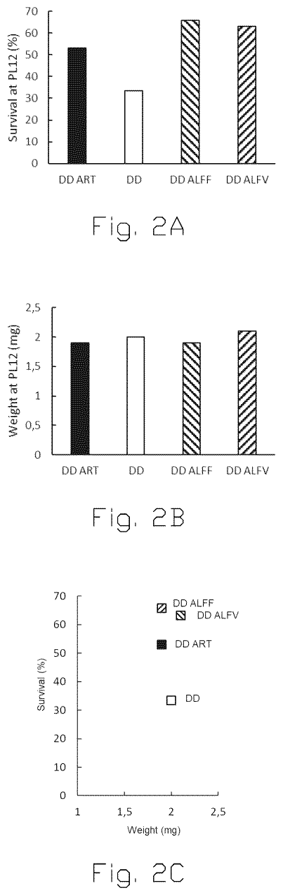

It was tested whether co-feeding a dry diet with either a fixed daily feed ration (ALFF) or a variable daily feed ration (ALFV) affected performance. In ALFF the same dose was given from M2 to PL4. In ALFV the feeding started at a lower dose at Z3/M1, reached a maximum at M3/Pl1 and was gradually reduced till PL4. After PL4, the larvae were fed dry diet only. The two ALF treatments were also compared with a treatment co-feeding Artemia and dry diet (DD ART), and with a treatment feeding dry diet only (DD). Results are shown in FIGS. 2A-C. The highest survival was obtained with the treatments on ALF (DD ALFF and DD ALFV) followed by the Artemia treatment (DD ART). The treatment receiving only dry diet (DD) performed worse (FIG. 2A). The weight of the shrimp in the different treatments was relatively equal (FIG. 2B). When survival and weight are combined to get an idea on the total biomass produced (FIG. 2C) it becomes clear that the treatments with ALF are giving a better overall biomass production than the treatment with Artemia and the treatment with only dry diet.

### Example 3

At the end of the hatchery (PL12 stage), the shrimps were followed in nursery facilities during 8 weeks. They were stocked with 350 post larva in two replicates and all received the same commercial diet comprising 25% protein and 9% fat according to a fixed feeding regime based on the body weight of the shrimps.

TABLE 1
Relationship between daily feed ratio
and body weight of the shrimp

| Weight of shrimp (g) | Diet fed relative to body weight (%) |
|---|---|
| 0.02-0.2 | 20 |
| 0.2-1 | 15 |
| 1-3 | 9 |
| 3-8 | 6.5 |
| 8-10 | 6 |
| 11-30 | 5 |
| >30 | 4-3 |

No Artemia or ALF were fed in this period. This period was used to evaluate the effect of dietary treatment (DD ART or DD ALF) during the hatchery phase on survival and biomass gain of shrimps during the nursery or growout phase.

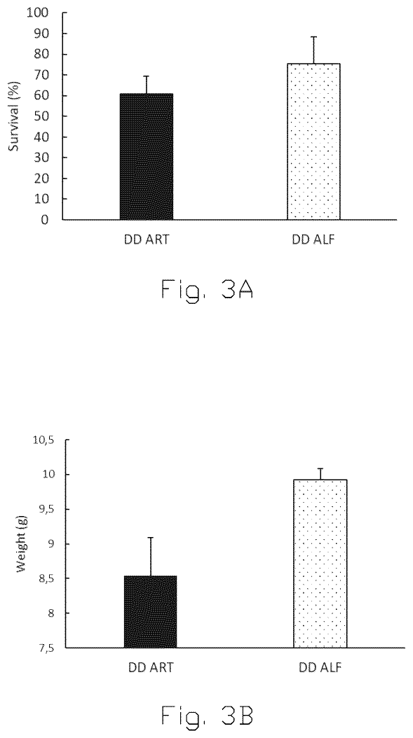

At the end of the nursery stage the survival of the shrimps that were fed DD ALF during the hatchery phase had increased survival (FIG. 3A) and average weight (FIG. 3B) compared to shrimps that had been fed DD ART during the hatchery phase. This demonstrates that shrimps can be reared without any live feed and show excellent performance in survival and growth in their further development in the nursery and grow-out ponds.

### Example 4

The hatchery trial described in Example 2 was repeated. The trial comprised four treatments (A,B,C and D) each with four replicates. All treatments received dry diet in the same quantities and were supplemented with Artemia except for treatment C where Artemia was replaced by ALF.

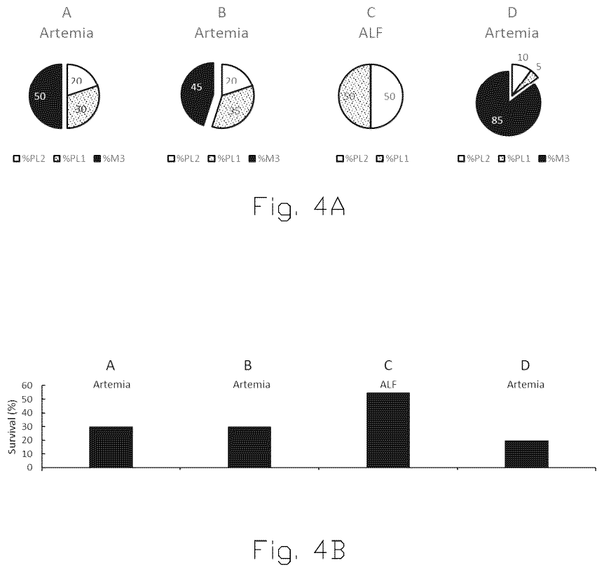

All treatments had good survival until the end of the mysis stage. Surprisingly, the animals receiving Artemia in addition to complete feed got problems in molting to the postlarval stages, whereas those animals that received the ALF treatment instead of Artemia experienced less problems in molting (FIG. 4A). The problems in molting resulted in a gradual and rapid mortality in the treatments A, B and D (FIG. 4B). This ended in total mortality in these treatments at PL5 while all replicated treatments in treatment C survived. Also, the animals receiving ALF in addition to complete feed reached the PL1/PL2 stage earlier than the animals receiving Artemia in addition to complete feed. At PL12 the experiment was finished with approximately the same survival rate in all the replicates of treatment C and no shrimp in all the other treatments. This shows that ALF not only has properties to help shrimp to overcome difficult developmental stages, it also offers a more hygienic and controlled production process reducing the biohazard of live feed.

### Example 5

The hatchery trial described in Example 4 was repeated in time with increased UV water filtration and daily siphoning of the tanks. Each of the 4 treatments (A,B,C and D) was again performed with 4 replicates. Treatments A and B received the same dry diet as in Example 4, treatment C and D received also the same dry diet but from a different lot number.

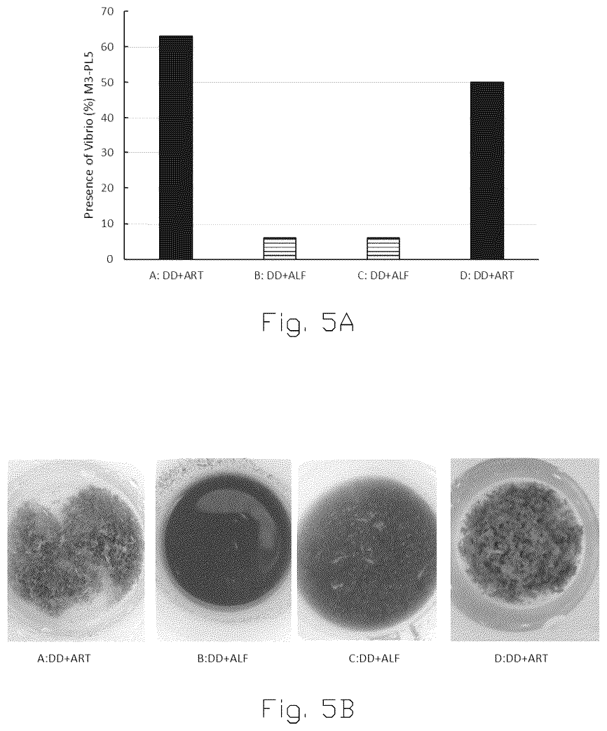

All treatments received dry diet in the same quantities and were supplemented with Artemia except for treatments B and C where Artemia was replaced by ALF. The diet consumption calculated per million shrimp produced was 3.5 kg for the dry diet and 2 kg Artemia cysts and 1.3 kg of ALF. The shrimps had difficulties to molt in the transition from M3 to PL1 but survival was not affected and for all treatments PL12 were produced with a survival between 40-45%. During the rearing period M3-PL5 the presence of Vibrio spp. was measured by plating a rearing water sample on TCBS medium. FIG. 5A shows that the occurrence of Vibrio spp. on the plates was much more pronounced in the Artemia treatments compared to the ALF treatments. It was also observed that during siphoning a lot more detritus from Artemia was found in the treatments A and D compared to the treatments that received ALF (FIG. 5B). It shows again that live feed such as Artemia can be replaced by ALF with the advantage of creating a lower bacterial load and less waste during larval rearing.

### Example 6

In order to find the origin of the Vibrio contamination, a simplified test was performed using beakers filled with seawater without shrimps. The test was performed with 3 replicates and 5 treatments. The treatments consisted of:
Control (no feeds)
Dry diet
Dry diet with ALF
Dry diet with cooked Artemia
Dry diet with live Artemia

The concentration of each diet corresponded to the equivalent of one day feeding. The diets were kept in suspension with an aeration. After one day, the sediment was filtered out and analyzed by plating the content of the filter on TCBS medium in triplicate. Vibrio spp. were counted after incubation of the plates. No Vibrio spp. were detected for any of the treatments except for the treatment containing live Artemia where all three plates turned yellow due to the presence of Vibrio spp.

| Treatments | Vibrio counts on TCBS plates |
|---|---|
| Control (no feeds) | −−− |
| Dry diet | −−− |
| Dry diet with ALF | −−− |
| Dry diet with cooked Artemia | −−− |
| Dry diet with live Artemia | +++ |

### Example 7

ALF was also co-fed with a commercial diet (GemmaMicro, manufactured by Skretting) in bass larvae and zebrafish larvae. It was found that the ALF was ingested by the fish larvae (both bass and zebrafish) as was observed by imaging (presence of ALF in the gut of the larvae was visible from a red colour, whereas the presence of GemmaMicro in the gut of the larvae was visible from a green colour). The fish larvae were clearly attracted by the ALF. Based on the excrement it was observed that the ALF has been ingested and digested.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. A nutrimental complement suitable for ingestion by larvae of shrimp or larvae of fish, comprising:
I) a particulate gel structure comprising:
a) agar;
b) an attractant; and
c) water;
and
II) an aqueous medium comprising at least one salt,
and the particulate gel structure is dispersed in the aqueous medium.

2. The nutrimental complement according to claim 1, wherein the nutrimental complement further comprises an ingredient selected from a group consisting of a colorant, an omega-3 fatty acid, and a phospholipid, or any combination thereof.

3. The nutrimental complement according to claim 2, wherein the nutrimental complement comprises a colorant, an omega-3 fatty acid, and a phospholipid.

4. The nutrimental complement according to claim 1, wherein the aqueous medium comprises at least 80 ppt salt.

5. The nutrimental complement according to claim 1, wherein the particulate gel structure is in the form of gelled particles.

6. The nutrimental complement according to claim 1, wherein the particulate gel structure has a density of between 0.995 and 1.200 g/ml.

7. The nutrimental complement according to claim 1, wherein the gel structure comprises between 0.01 and 10 wt % agar on wet-weight basis.

8. The nutrimental complement according to claim 2, wherein the omega-3 fatty acid comprises docosahexaenoic acid (DHA).

9. The nutrimental complement according to claim 2, wherein the phospholipid comprises lecithin.

10. The nutrimental complement according to claim 2, wherein the colorant is selected from the group consisting of carotenoids, carbon, clay, mineral, anthocyanins, or colorant algae.

11. The nutrimental complement according to claim 10, wherein the colorant is a carotene.

12. The nutrimental complement according to claim 10, wherein the colorant is astaxanthin.

13. The nutrimental complement according to claim 1, wherein the aqueous medium comprises sodium chloride (NaCl) as a salt.

14. The nutrimental complement according to claim 1, wherein the weight ratio between the particulate gel structure and the aqueous medium is between 0.2:1 to 1:0.2.

15. A method of preparing a nutrimental complement suitable to be co-fed to shrimp larvae or fish larvae, wherein the method comprises the steps of:
i) congealing a gelling mixture comprising agar, water and an attractant, and optionally an omega-3 fatty acid, a phospholipid and a colourant to form a particulate gel structure;
ii) optionally, wet sieving the particulate gel structure to obtain appropriately sized particulate gel structure; and
iii) dispersing the particulate gel structure in an aqeuous medium comprising at least one salt to obtain a nutrimental complement suitable for ingestion by larvae of shrimp or larvae of fish.

16. A nutrimental complement obtainable by the method of claim 15.

17. A method of feeding larvae of shrimp or larvae of fish, increasing growth of larvae of shrimp or larvae of fish, increasing total biomass of larvae of shrimp or larvae of fish, reducing germs in the rearing of fish larvae or shrimp larvae, and/or reducing waste in the rearing of fish larvae or shrimp larvae, wherein the method comprises co-feeding the larvae of shrimp or larvae of fish with the nutrimental complement according to claim 1 and at least one wet or dry feed.

18. The method according to claim 17, wherein the nutrimental complement and the at least one wet or dry feed are fed to the larvae of shrimp or larvae of fish at different frequencies, such that the nutrimental complement is fed to the larvae of shrimp or larvae of fish at a lower frequency than the at least one wet or dry feed.

19. The method according to claim 17, wherein the nutrimental complement is co-fed with the at least one wet or dry feed during a hatchery phase.

20. A nutrimental complement according to claim 1, for non-medical use in increasing survival of larvae of shrimp or larvae of fish.
